(19) United States
(12) Patent Application Publication
(10) Pub. No.: US 2019/0369781 A1
(43) Pub. Date: Dec. 5, 2019

(54) TOUCH PANEL WITH TRANSPARENT FLEXIBLE ELECTRODES AND MANUFACTURING METHODS THEREOF

(71) Applicant: ILJIN DISPLAY CO., LTD., Chungcheongbuk-do (KR)

(72) Inventors: Ji Eun HWANG, Chungcheongbuk-do (KR); Nam Kyun KIM, Chungcheongbuk-do (KR); Sung Jin KIM, Chungcheongbuk-do (KR); Sung Taek LIM, Chungcheongbuk-do (KR); Yong Hee SHIN, Chungcheongbuk-do (KR)

(73) Assignee: ILJIN DISPLAY CO., LTD.

(21) Appl. No.: 16/382,457

(22) Filed: Apr. 12, 2019

(30) Foreign Application Priority Data
May 29, 2018 (KR) 10-2018-0061187

(51) Int. Cl. G06F 3/047; G02F 1/1335

(52) U.S. Cl. CPC G06F 3/047; G02F 1/133514

(57) ABSTRACT

Disclosed is a touch panel with transparent flexible electrodes. The present invention provides a touch panel having a sensing electrode pattern and a wiring pattern for electrically connecting the sensing electrode pattern formed on a substrate, which includes: a first sensing electrode pattern formed on a first plane on the first substrate, a second sensing electrode pattern formed on a second plane having a different height from the first plane on the substrate and having a metal nano wire, and first and second wiring patterns formed coplanarly with the first sensing electrode pattern; and a first interlayer insulating film laminated on the substrate and insulating the first sensing electrode pattern and the second sensing electrode pattern, in which the touch panel includes a via electrode electrically connecting a part of the second sensing electrode pattern and a part of the second wiring pattern via the interlayer insulating film.

### CROSS-REFERENCE TO RELATED APPLICATIONS

This application claims priority to and the benefit of Korean Patent Application No. 10-2018-0061187 filed in the Korean Intellectual Property Office on May 29, 2018, the entire contents of which are incorporated herein by reference.

### FIELD

The present invention relates to a touch panel and a display device including the same, and more particularly, to a touch panel with transparent flexible electrodes and a display device including the same.

### BACKGROUND

Display devices include a liquid crystal display device (LCD), a plasma display panel (PDP), an organic light emitting display device (OLED), an electrophoretic display device (EPD), and the like.

Narrow bezel technology is technology for reducing a size of a bezel whose image is not displayed at an edge of a display panel to relatively increase the size of an effective screen on which the image is displayed on display panels having the same size. Manufacturers of the display devices have made various attempts to realize a bezel defined by a width of a non-display area outside a display area to be smaller.

FIG. 1 is a cross-sectional view schematically illustrating an exemplary laminated structure of a liquid crystal display device as an example of a display device.

Referring to FIG. 1 the liquid crystal display device may include a window panel 10, a touch panel 20 disposed below the window panel, and a display panel 70 disposed below the touch panel 20.

The window panel 10 includes a cover 12 for protecting the touch panel 20 and the display panel 70 and an area A corresponding to a printing area 14 formed on a rear surface of the cover of the window panel 10 forms a Bezel of the display device.

The display panel 70 may have a structure in which an array substrate 60 as a lower substrate and a color filter substrate 40 as an upper substrate are face-to-face bonded with a liquid crystal layer 50 interposed therebetween. In the color filter substrate 40, an area corresponding to a display area VA may include a color filter layer 43 made up of RGB color filter patterns corresponding to a boundary of each pixel area. Further, a pixel black matrix 45 is provided between color filter layers 33. In addition, a periphery black matrix 41 may be provided inside an outermost portion of the display area VA while surrounding the display area VA.

The touch panel 20 includes a transparent substrate 21 and a transparent sensing electrode pattern 23 and a wiring pattern 25 are formed on the transparent substrate 21. Preferably, the wiring pattern 25 is formed outside the display area VA and most of the sensing electrode pattern 23 other than a distal end is formed in the display area VA and a partial pattern of an end portion is formed over an outside of the display area. Further, the sensing electrode pattern 23 may be made of a transparent conductive material, and the wiring pattern 25 is made of conductive metal and the wiring pattern 25 is electrically connected to the sensing electrode pattern 23. It is illustrated that in the exemplarily illustrated touch panel 20, the sensing electrode pattern and the wiring pattern are formed on one substrate, but the sensing electrode pattern and the wiring pattern may be formed on a multi-layer substrate.

Since the wiring pattern 25 is made of opaque conductive material in the touch panel 20, the wiring pattern 25 is generally formed in a lower area of the printing area 14 of the window panel 10. Accordingly, for implementation of a narrow Bezel, in order to reduce a width of the printing area 14, the width of the wiring pattern 25 needs to be reduced to be narrow.

Meanwhile, in recent years, there has been an attempt to implement the transparent sensing electrode pattern 23 of the touch panel by a transparent flexible electrode by using a metal nano wire such as Ag.

FIG. 2 is a diagram schematically illustrating an example 10 of a touch panel in the related art, which has a transparent flexible electrode.

Referring to FIG. 2, the touch panel 10 may include a first substrate 10A, a second substrate 10B, and a printed circuit board 10C. The second substrate 10B is disposed below a cover substrate and the first substrate 10A is disposed below the second substrate 10B, and each of the second substrate 10B and the first substrate 10A may be bonded using a bonding material such as an optical clear adhesive (OCA), etc.

Sensing electrode patterns 11A and 11B and wiring electrode patterns 13A and 13B may be formed on the first substrate 10A and the second substrate 10B, respectively and the sensing electrode pattern and the wiring electrode pattern are electrically connected to each other on each substrate. In this case, in order to ensure transparency and flexibility of the substrate, a first sensing electrode pattern of the first substrate 10A and a second sensing electrode pattern 11B of the second substrate 10B are made of conductive nano wire (AgNW) such as Ag and a material such as a metal mesh or CNT.

Meanwhile, the printed circuit board 10C is attached to a part of each of the first substrate 10A and the second substrate 10B to be electrically connected to a first wiring electrode pattern 13A and a second wiring electrode pattern 13B.

The touch panel adopting the transparent flexible electrode described above has the following problem.

First, since the metal nano wire is an aggregate of fine nano wires, the metal nano wire is electrically connected to the wiring pattern by a contact point, and as a result, the metal nano wire has a problem in that the metal nano wire has high contact resistance.

Since the metal nano wire has a low mechanical strength, it is difficult to apply a vapor deposition method such as sputtering when forming a wiring pattern material on the metal nano wire. For this reason, when a printing method using a powder paste is applied, a line width of the wiring pattern cannot but increase as compared with a conductive material deposited by a thin film, etc. due to a limitation of a size of a paste and a thickness of a coating film by the printing method, and as a result, there is a limit in implementing the narrow Bezel.

### SUMMARY

The present invention has been made in an effort to provide a touch panel with transparent flexible electrodes having a structure to implement a narrow Bezel.

The present invention has also been made in an effort to provide a touch panel with transparent flexible electrodes having a structure to implement a high-resolution line width because vapor thin-film deposition of a wiring pattern is enabled.

The present invention has also been made in an effort to provide a touch panel having low contact resistance in a contact area between a transparent flexible electrode and a wiring pattern.

The present invention has also been made in an effort to provide a manufacturing method for reducing the number of process steps in manufacturing the touch panel.

An exemplary embodiment of the present invention provides a touch panel having a sensing electrode pattern and a wiring pattern for electrically connecting the sensing electrode pattern formed on a substrate, which includes: a first sensing electrode pattern formed on a first plane on the first substrate, a second sensing electrode pattern formed on a second plane having a different height from the first plane on the substrate and including a metal nano wire, and first and second wiring patterns formed coplanarly with the first sensing electrode pattern; and a first interlayer insulating film laminated on the substrate and insulating the first sensing electrode pattern and the second sensing electrode pattern, in which the touch panel includes a via electrode electrically connecting a part of the second sensing electrode pattern and a part of the second wiring pattern via the interlayer insulating film.

In the present invention, the first plane may be a substrate surface and the second plane is a first interlayer insulating film surface. On the contrary, the touch panel may further include a second interlayer insulating film between the first sensing electrode pattern, the first wiring pattern, and the second wiring pattern, and the substrate.

In the present invention, the via electrode may be formed on an end of the second sensing electrode pattern. In this case, the second wiring pattern may include a connection portion and a wiring portion, and the via electrode may electrically connect the end of the second sensing electrode pattern and the connection portion of the second wiring pattern. Further, in this case, the second wiring pattern may include the connection portion and the wiring portion, the via electrode may electrically connect the end of the second sensing electrode pattern and the connection portion of the second wiring pattern, the second sensing electrode pattern and the connection portion of the second wiring pattern may not overlap with each other in plane, and the second sensing electrode pattern and the connection portion of the second wiring pattern may partially overlap with each other in plane.

In the present invention, the via electrode may include metal particles having a sub-micron size.

In the present invention, the first interlayer insulating film is a cured photoresist or polymer film form.

Another exemplary embodiment of the present invention provides a method for manufacturing a touch panel, which includes: providing a substrate having a plurality of first sensing electrode patterns, a plurality of wiring patterns, and a second wiring pattern; forming an insulating layer and a sensing electrode layer including a metal nano wire on the substrate; forming a via hole that opens a part of the second wiring pattern by patterning a part of the insulating layer; and forming a via electrode electrically connecting the sensing electrode layer on the insulating layer and a part of the second wiring pattern by filling the via hole.

In this case, the insulating layer in the providing of the insulating layer may be a photoresist and the patterning of the insulating layer may include curing the photoresist.

In the present invention, each of the second wiring pattern and the via electrode may include metal powder and the via electrode may include metal particles having a sub-micron size.

According to an exemplary embodiment of the present invention, a touch panel can be provided, which has transparent flexible electrodes having a structure to implement a high-resolution wiring line width at a periphery portion of a panel and implement a narrow Bezel.

According to an exemplary embodiment of the present invention, a touch panel can be provided, which has low contact resistance in a contact area between a transparent flexible electrode and a wiring pattern.

According to an exemplary embodiment of the present invention, the touch panel is suitable for reducing the number of processing steps in manufacturing the panel.

### BRIEF DESCRIPTION OF THE DRAWINGS

FIG. 1 is a diagram schematically illustrating an example of a configuration of a display device in the related art.

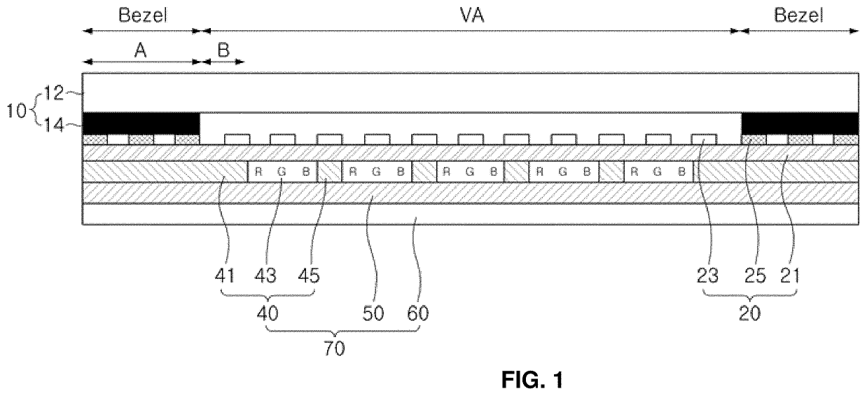

FIG. 2 is a diagram schematically illustrating an example of a touch panel in the related art.

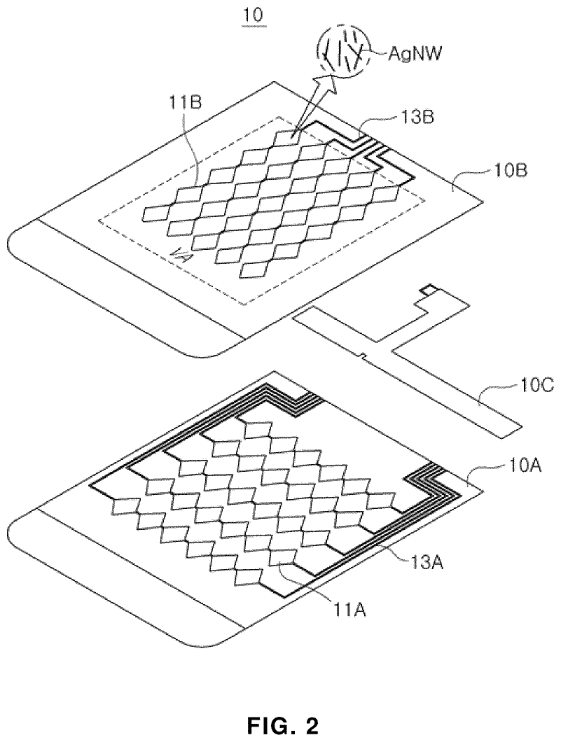

FIG. 3 is a plan view schematically illustrating a touch panel according to an exemplary embodiment of the present invention.

FIG. 4 is a diagram schematically illustrating a part of a layout of a substrate level in the touch panel of FIG. 3.

FIG. 5 is a cross-sectional view taken along line A-A′ in the vicinity of a via electrode of a lower end of the touch panel of FIG. 3.

FIG. 6 is a cross-sectional view taken along line B-B′ in the vicinity of the via electrode of the touch panel of FIG. 3.

FIGS. 7A, 7B, 7C, 7D and 7E are a cross-sectional view sequentially illustrating a manufacturing process of a touch panel according to an exemplary embodiment of the present invention.

### DETAILED DESCRIPTION

Hereinafter, the present invention will be described in detail by describing an exemplary embodiment of the present invention with reference to drawings.

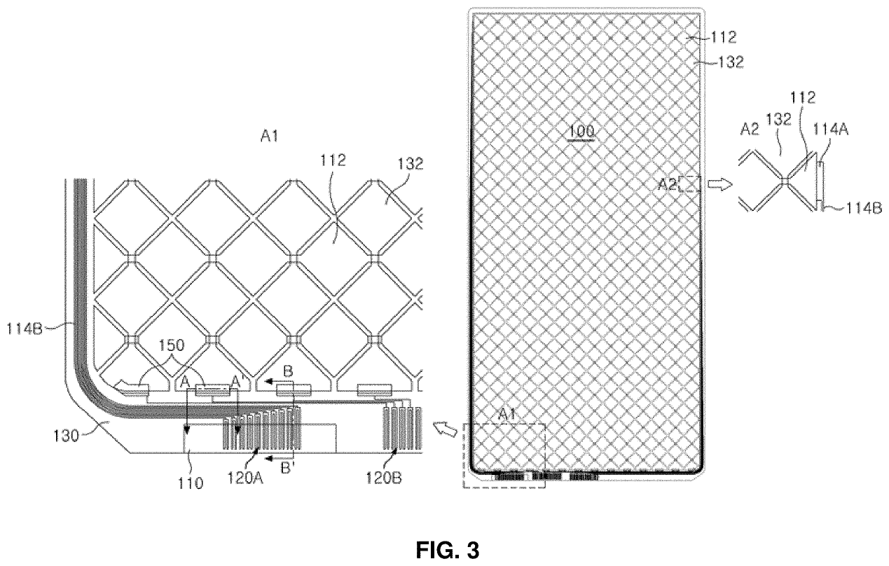

FIG. 3 is a plan view of a touch panel according to an exemplary embodiment of the present invention. Some of structures implemented in different layers as needed for convenience of description or illustration are superimposed on a projected image in the drawings.

Referring to FIG. 3, the touch panel 100 includes a plurality of first sensing electrode patterns 112 arranged in parallel in a first direction (e.g., a horizontal direction of a panel) and a plurality of second sensing electrode patterns 132 arranged in parallel in a second direction (e.g., a vertical direction of the panel).

Individual first sensing electrode patterns 112 may be connected to a printed circuit board through corresponding first wiring patterns 114A and 114B and a first wiring pad 120A provided at edges of the touch panel. Similarly, individual second sensing electrode patterns 132 may be connected to the printed circuit board through corresponding second wiring patterns 134A and 134B and a second wiring pad 120B provided at the edges of the touch panel. In this case, installation locations of a connection portion 114A of the first wiring pattern and a connection portion 134A of the second wiring pattern may be determined by arrangement directions of the sensing electrode patterns and as illustrated in FIG. 3, the first sensing electrode pattern arranged in the horizontal direction may be provided at a left and/or right edge of a panel and the second sensing electrode pattern arranged in the vertical direction may be provided at an upper and/or lower edge of the panel. It is to be understood by those skilled in the art that a part of each of the connection portions 114A and 134A of the wiring patterns may be implemented to be partitioned into a left side or a right side and a left side or an upper side or a lower side or integrated into any one side due to implementation of the narrow Bezel or due to other reasons.

In the present invention, the first sensing electrode pattern 112 and the second sensing electrode pattern 132 of the touch panel 100 may be implemented to have multi-layer structures in different heights from the substrate. For example, when the first sensing electrode pattern 112 is formed on the substrate 110, the second sensing electrode pattern 132 may be disposed at a different location with an insulating layer interposed between the second sensing electrode pattern 132 and the first sensing electrode pattern 112.

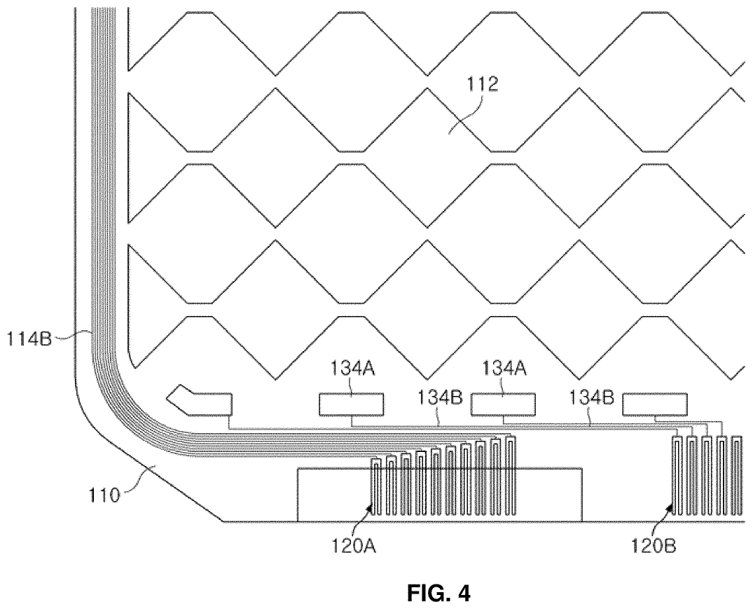

FIG. 4 is a diagram schematically illustrating a part of a layout of a substrate level in the multi-layer touch panel.

Referring to FIG. 4, a plurality of first sensing electrode patterns 112, first wiring patterns 114A and 114B, second wiring patterns 134A and 134B, and a first wiring pad 120A and a second wiring pad 120B are provided on a substrate 110. As illustrated in FIG. 4, the first sensing electrode pattern 112, the first wiring patterns 114A and 114B, and the second wiring patterns 134A and 134B are positioned coplanarly on the substrate.

The first sensing electrode pattern 112 may contain at least one transparent conductive material selected from a group consisting of indium oxide, tin oxide, indium tin oxide (ITO), copper oxide, carbon nanotube (CNT), metal nano wire, conductive polymer, and graphene. Further, the metal nano wire refers to a wire type conductive metal structure having a predetermined range of wire diameter and preferably, the wire diameter may be 30 micrometers or less and a material thereof may be, for example, at least one metal selected from silver, gold, copper, nickel, gold-plated silver, platinum, and palladium or an alloy thereof.

The first wiring patterns 114A and 114B may be implemented by a conductive metal material such as silver or copper (Cu).

Referring back to FIG. 3, the second sensing electrode pattern 132 and a via electrode 150 for electrically connecting the second sensing electrode pattern 132 with the connection portion 134A of the second wiring pattern below the second sensing electrode pattern 132 are provided above the layout of FIG. 4. The second sensing electrode pattern 132 is electrically insulated from another structure therebelow by an interlayer insulating film 130.

In the present invention, the second sensing electrode pattern 132 includes the metal nano wire. In this case, the metal nano wire may be the metal nano wire made of at least one metal selected from silver, gold, copper, nickel, gold-plated silver, platinum, and palladium and the alloy thereof.

The first wiring patterns 114A and 114B may be implemented by the conductive metal material such as silver or copper (Cu).

In the present invention, the interlayer insulating film may be an insulative resin layer. Specifically, the interlayer insulating film may be implemented by a photosensitive resin layer such as a photoresist. In this case, the interlayer insulating film may be a photoresist pattern cured through exposure and development.

The via electrode 150 may be implemented by a metal material of the same material as or a different material from the wiring pattern. In the present invention, it is advantageous in that metal particles constituting the via electrode 150 may be implemented by particles smaller than metal particles constituting a wiring pattern formed from a powder paste. As described below, the size of the metal particle for forming the wiring pattern is limited in a photo process. For example, it is difficult to ensure sufficient exposure of a wiring pattern constituted by fine metal particles having an average particle size of 1 μm or less over a thickness of a lower photosensitive resin layer. However, since a via hole may be filled after forming the wiring pattern, there is no limitation of the aforementioned particle size in the via electrode 150. Therefore, the via electrode 150 made of metal powder having a fine particle size is adopted to provide a sufficient contact point with the nano wire of the second sensing electrode pattern 132, thereby enhancing electrical characteristics of the electrode.

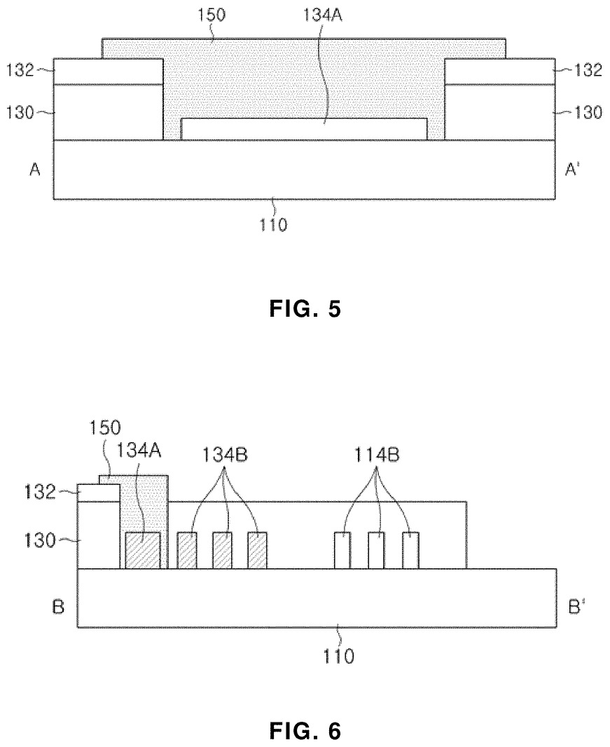

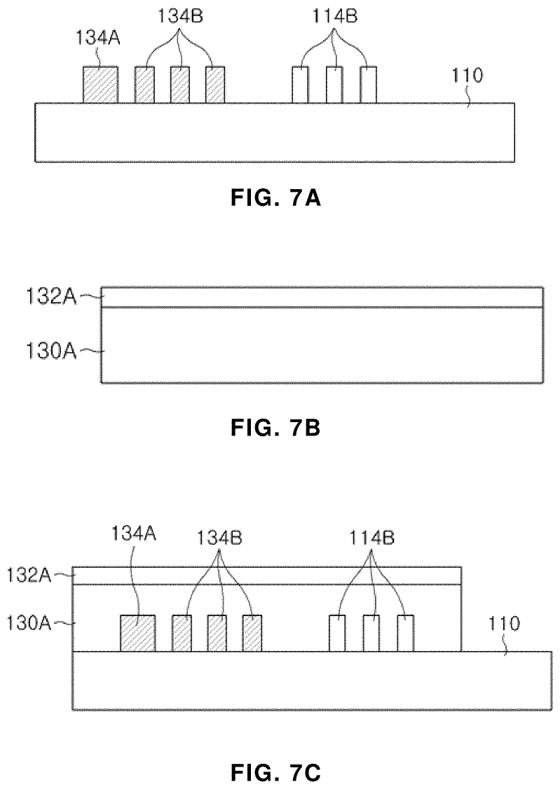

Hereinafter, an interlayer structure of the touch panel will be described with reference to FIGS. 5 and 6.

FIG. 5 is a cross-sectional view taken along line A-A′ in the vicinity of a via electrode of a lower end of the touch panel of FIG. 3 and FIG. 6 is a cross-sectional view taken along line B-B′ in the vicinity of the via electrode of the touch panel of FIG. 3.

First, referring to FIG. 5, the substrate 110, the second wiring pattern 134A, the interlayer insulating film 130, and the second sensing electrode pattern 132 are formed below the via electrode 150. The via electrode 150 electrically connects the second wiring pattern 134B and the second sensing electrode pattern 132 via the interlayer insulating film 130.

Next, referring to FIG. 6, the via electrode is electrically contacted with the connection portion 134A of the second wiring pattern through the via electrode 150 in an outer direction of the second sensing electrode pattern 132 and wiring portion 134B of the plurality of second wiring patterns are provided at an outer side thereof, and the wiring portion 134B of the first wiring pattern is provided at an outer side thereof again. The wiring portions 134B and 114B of the first and second wiring patterns are covered with the interlayer insulating film.

An interlayer structure of the present invention, which is described with reference to FIGS. 5 and 6, is not limited to an illustrated form. In FIGS. 5 and 6, it is illustrated that the second sensing electrode pattern 132 does not overlap with the connection portion 134A of the second wiring pattern in plane, but on the contrary, the second sensing electrode pattern 132 and the connection portion 134A of the second wiring pattern may be disposed to partially overlap with each other in a plane.

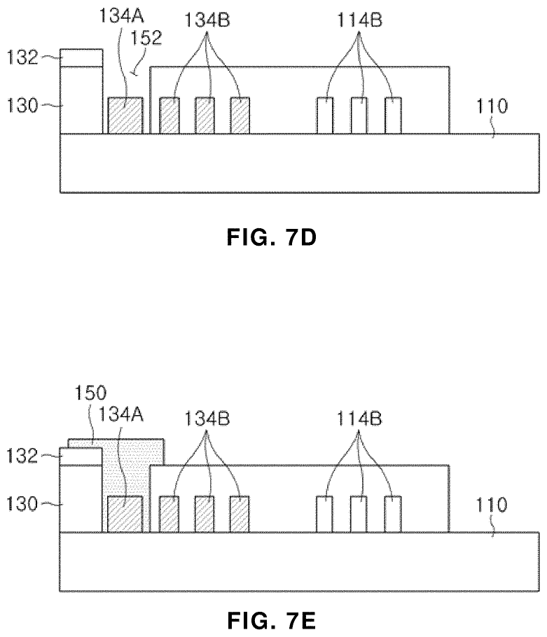

Hereinafter, a manufacturing process of the touch panel according to the present invention will be described. FIGS. 7A to 7E are flowcharts schematically illustrating a manufacturing process of a touch panel on a cross-sectional view taken along line B-B′ on a periphery of the touch panel.

As illustrated in FIG. 7A, the substrate 110 is provided, which has a first sensing electrode pattern (not illustrated), the first wiring patterns 114A and 114B, and the second wiring pattern 134B. A technique known to the art may be applied to a process of forming the first sensing electrode pattern and the wiring pattern on the substrate. For example, the sensing electrode layer and the wiring layer may be laminated on the substrate and the sensing electrode layer and the wiring layer may be patterned with a desired pattern by a photolithography process using a photoresist. Further, unlike this, a photosensitive resin layer may be formed on the substrate, the sensing electrode layer and the wiring layer may be formed thereon, and then, the sensing electrode layer and the wiring layer may be patterned by using the photosensitive resin layer. In this case, the sensing electrode pattern or the wiring pattern may be present while being laminated on the cured photosensitive resin pattern without directly contacting the substrate.

Next, as illustrated in FIG. 7B, a second sensing electrode layer 132A and an insulating layer 130A are provided. Preferably, in the exemplary embodiment, the metal nano wire may be used as the second sensing electrode layer 132A as described above.

Subsequently, as illustrated in FIG. 7C, respective structures of FIGS. 7A and 7B are joined to each other. Such a joining scheme is just an exemplary scheme of acquiring a lamination structure illustrated in FIG. 7C. On the contrary, a scheme may be used in which the insulating layer and the sensing electrode layer are sequentially applied or deposited on the structure of FIG. 7A, of course.

Subsequently, referring to FIG. 7D, the second sensing electrode layer 132A and the insulating layer are patterned to form a via hole 152 for exposing a part of the second wiring pattern, that is, the connection portion 114A of the second wiring pattern. Such a process may include patterning of the insulating layer and patterning of the second sensing electrode layer and each process may be performed in-situ or sequentially by applying a photolithography process and/or an etching process.

Meanwhile, in the present invention, when the photosensitive resin layer such as a photoresist film is used as the insulating layer 130A, the process step for forming the pattern may be reduced. For example, a pattern is cured, which remains by removing the photoresist below the sensing electrode layer corresponding to a via hole area by appropriate exposure and development processes to form the interlayer insulating film, and as a result, a forming process of an additional photoresist film on the sensing electrode layer may be omitted.

Subsequently, referring to FIG. 7E, the via electrode 150 is formed by filling the formed via hole 152 with the conductive metal material. The metal material may be filled by various schemes including screen printing, a direct printing method, coating, and the like by using the metal powder paste. In the present invention, since the photolithography process is not directly applied to the electrode material, the limitation in size or shape of the particle is not applied to filling of the via electrode 150. For example, metal powder having a fine particle size having a nano micron or sub-micron size may be used and the filled metal powder may provide multiple contact points for the nano wire, thereby reducing the contact resistance of the electrode.

Hereinabove, the exemplary embodiment of the present invention has been described, but the technical spirit of the present invention is limited to the exemplary embodiment and the present invention may be variously implemented within the scope departing from the technical spirit of the present invention embodied in the appended claims.

What is claimed is:

1. A touch panel having a sensing electrode pattern and a wiring pattern for electrically connecting the sensing electrode pattern formed on a substrate, the touch panel comprising:
a first sensing electrode pattern formed on a first plane on the first substrate, a second sensing electrode pattern formed on a second plane having a different height from the first plane on the substrate and having a metal nano wire, and first and second wiring patterns formed coplanarly with the first sensing electrode pattern; and
a first interlayer insulating film laminated on the substrate and insulating the first sensing electrode pattern and the second sensing electrode pattern,
wherein the touch panel includes a via electrode electrically connecting a part of the second sensing electrode pattern and a part of the second wiring pattern via the interlayer insulating film.

2. The touch panel of claim 1, wherein the first plane is a substrate surface and the second plane is a first interlayer insulating film surface.

3. The touch panel of claim 1, further comprising:
a second interlayer insulating film between the first sensing electrode pattern, the first wiring pattern, and the second wiring pattern, and the substrate.

4. The touch panel of claim 1, wherein the via electrode is formed on an end of the second sensing electrode pattern.

5. The touch panel of claim 4, wherein the second wiring pattern includes a connection portion and a wiring portion, and
the via electrode electrically connects the end of the second sensing electrode pattern and the connection portion of the second wiring pattern.

6. The touch panel of claim 4, wherein the second wiring pattern includes the connection portion and the wiring portion,
the via electrode electrically connects the end of the second sensing electrode pattern and the connection portion of the second wiring pattern, and
the second sensing electrode pattern and the connection portion of the second wiring pattern do not overlap with each other in plane.

7. The touch panel of claim 4, wherein the second wiring pattern includes the connection portion and the wiring portion,
the via electrode electrically connects the end of the second sensing electrode pattern and the connection portion of the second wiring pattern, and
the second sensing electrode pattern and the connection portion of the second wiring pattern partially overlap with each other in plane.

8. The touch panel of claim 4, wherein the via electrode includes metal particles having a sub-micron size.

9. The touch panel of claim 1, wherein the first interlayer insulating film is a cured photoresist.

10. A method for manufacturing a touch panel, the method comprising:
providing a substrate having a plurality of first sensing electrode patterns, a plurality of wiring patterns, and a second wiring pattern;
forming an insulating layer and a sensing electrode layer on the substrate;
forming a via hole that opens a part of the second wiring pattern by patterning a part of the insulating layer; and
forming a via electrode electrically connecting the sensing electrode layer on the insulating layer and a part of the second wiring pattern by filling the via hole.

11. The method of claim 10, wherein the insulating in the providing of the insulating layer is a photoresist.

12. The method of claim 11, wherein in the forming of the via hole, the patterning of the insulating layer includes curing the photoresist.

13. The method of claim 10, wherein the via electrode includes metal particles having a sub-micron size.
